(19) United States
(12) Patent Application Publication
(10) Pub. No.: US 2022/0351221 A1
(43) Pub. Date: Nov. 3, 2022

(54) METHODS, SYSTEMS, ARTICLES OF MANUFACTURE AND APPARATUS TO DETERMINE HEADROOM METRICS FROM MERGED DATA SOURCES

(71) Applicant: THE NIELSEN CONSUMER (US), LLC, New York, NY (US)

(72) Inventors: Michael Zenor, Cedar Park, TX (US); John Mansour, North Aurora, IL (US); Yun Xue, Starkville, MS (US)

(21) Appl. No.: 17/622,204

(22) PCT Filed: Jul. 8, 2020
(86) PCT No.: PCT/US2020/041181

§ 371 Date: Dec. 22, 2021

Related U.S. Application Data
(60) Provisional application No. 62/940,630, filed on Nov. 26, 2019.
(60) Provisional application No. 62/871,290, filed on Jul. 8, 2019.

(51) Int. Cl. G06Q 30/02; G06K 9/62

(52) U.S. Cl. CPC G06Q 30/0204; G06K 9/6215; G06K 9/6218

(57) ABSTRACT

Methods, apparatus, systems and articles of manufacture are disclosed to determine headroom. An example apparatus disclosed herein includes a data retriever to retrieve a first data set and a second data set, the first and second data sets including observations, an overlap calculator to merge respective ones of the observations to form an overlap data set, the respective ones of the observations merged based on first tier parameters, a similarity calculator to calculate similarity scores for pairs of the respective ones of the observations in the overlap data set, the similarity score based on second tier parameters, and a data joiner to associate respective ones of the similarity scores with corresponding households associated with the respective ones of the observations.

### RELATED APPLICATION

U.S. patent application Ser. No. 62/871,290 filed on Jul. 8, 2019, and U.S. patent application Ser. No. 62/940,630 filed on Nov. 26, 2019 are hereby incorporated herein by reference in their entireties. Priority to U.S. patent application Ser. No. 62/871,290 and U.S. patent application Ser. No. 62/940,630 is hereby claimed.

### FIELD OF THE DISCLOSURE

This disclosure relates generally to the technical field of market research and market strategy design, and, more particularly, to methods, systems, articles of manufacture and apparatus to determine headroom metrics from merged data sources.

### BACKGROUND

In recent years, market data has been cultivated from many different sources and combinations of sources. Market data includes sales information and demographics information

### BRIEF DESCRIPTION OF THE DRAWINGS

FIG. 1 is a schematic illustration of an example headroom determination system and a headroom determiner suitably constructed in accordance with teachings of this disclosure to determine headroom metrics from merged data sources.

FIGS. 2-7 are flowcharts representative of example machine readable instructions which may be executed to implement the example headroom determination system and/or the example headroom determiner of FIG. 1 to determine headroom metrics from merged data sources.

FIG. 8 is a block diagram of an example processing platform structured to execute the instructions of FIGS. 2-7 to implement the example headroom determination system and/or the example headroom determiner of FIG. 1.

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering (e.g., temporal or physical) in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approxitnately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/− 1 second,

### DETAILED DESCRIPTION

Combining data from two or more marketing data sources enables the exposure of one or more market design strategies that can help improve product and/or service sales. In some examples, a marketing database includes a vast amount of data related to consumer behavior, such as large databases containing consumer purchase instances (observations), consumer demographics information, etc. Such large data sources may include millions or hundreds of millions of data points, but may include a relatively low degree of granular information at each data entry. In conventional statistical terminology, the data can be considered “predictor data” or “X” variable data sources.

As used herein, relatively large data sources with relatively limited data granularity are referred to herein as “predictor data sources” (or variants thereof). Predictor data sources (e.g., predictor databases) may include, but are not limited to, frequent shopper databases managed by a retailer (e.g., loyalty databases) that include millions of consumers and/or consumer transactions (observations), Such loyalty databases may include a purchase date, a purchase item, a purchase price and/or a consumer name associated with the purchase activity. In some examples, the predictor data source may indicate how much a particular household spent at a particular fast food restaurant during the last month, a total amount of spend on apparel in the last month, etc. However, such loyalty databases do not typically include one or more protocols to ensure data accuracy. For instance, while a loyalty database may include a purchase instance for a particular consumer at a particular retailer, there are no guarantees that the associated consumer information is accurate or otherwise provided in a truthful manner (e.g., the consumer provided inaccurate or false information for the purpose of obtaining the loyalty card from the retailer).

Unlike predictor data sources (e.g., predictor databases), other types of market data sources may include relatively granular data samples, but the quantity of such data samples is substantially lower (e.g., 100,000 households) than that of the predictor data sources (e.g., 1.2 million households). For example, the Nielsen® Homescan® system is a managed database having data accuracy protocols to ensure that the collected data meets one or more statistical expectations. Detailed demographics information for each data sample includes age, gender, income, race and/or any number of additional/alternate characteristics, in which such characteristics are deemed trustworthy and/or otherwise accurate. As used herein, such data sources are (statistically) referred to as “criterion data sources” (e.g., criterion databases) or “Y” variable data sources. Typically, criterion data refers to a variable that is being predicted, also referred to as a dependent variable. A dependent variable is affected-by (influenced by) an independent variable. For instance, if medicine is an independent variable, then the presence or absence of an ailment is the dependent variable that is affected by the medicine. In a marketing example, if advertisements (e.g., designed advertising campaigns that target particular demographics, particular creative types, etc.) are an independent variable, then product/service sales are a corresponding dependent variable that is affected by the influence (independent variable).

Examples disclosed herein infer or predict dependent variables on to the relatively large predictor data sources. For example, a retailer may have a loyalty database (e.g., a predictor data source) with millions of customers that only have corresponding information of purchases at that particular retailer, but the retailer may wish to predict purchases of customers at competing retailers front a relatively small multi-retailer panel (e.g., a relatively smaller, but more granular criterion data source). In another example, a data warehouse may have limited demographic or aggregated purchase information on consumers (e.g., total spending at retailers “I,” “J,” and “K”), and seek to infer or predict detailed purchasing information at retailer “I.”

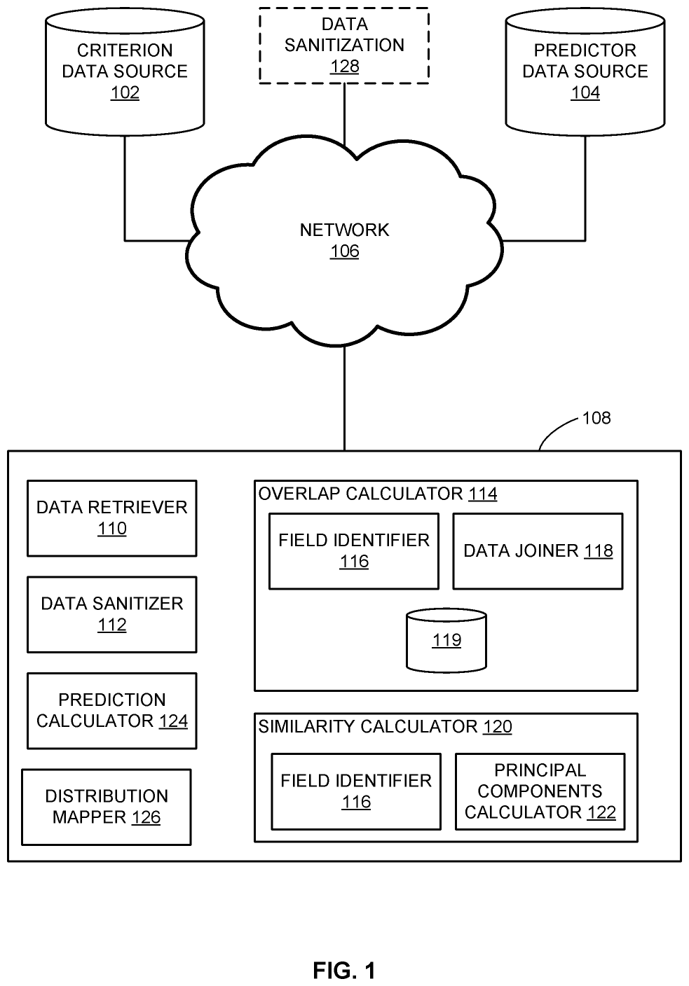

FIG. 1 is a schematic illustration of an example headroom determination system 100. The example headroom determination system 100 includes an example criterion data source 102, an example predictor data source 104, and an example headroom determiner 108 communicatively connected to the aforementioned data sources via an example network 106 (e.g., an intranet, the Internet, a wide area network (WAN), etc.). The example headroom determiner 108 includes an example data retriever 110, an example data sanitizer 112, an example prediction calculator 124, and an example distribution mapper 126. The example headroom calculator 108 also includes an example overlap calculator 114, which includes an example field identifier 116, an example data joiner 118, and an overlap data storage 119. The example headroom calculator 108 also includes an example similarity calculator 120, which includes an example field identifier 116 (which, in some examples, can be the same field identifier of the example overlap calculator 114) and an example principal components calculator 122. in the illustrated example of FIG. 1, the network 106 (e.g., implemented by one or more routers, switches, etc.) implements means for handling network traffic, the data retriever 110 implements means for retrieving data, the data sanitizer 112 implements means for sanitizing data, the prediction calculator 124 implements means for calculating predictions, the distribution mapper 126 implements means for mapping distributions, the overlap calculator 114 implements means for calculating overlap, the field identifier 116 implements means for identifying fields, the data joiner 118 implements means for joining, the similarity calculator 120 implements means for calculating similarity, the principal components calculator 122 implements means for calculating principal components, and the headroom determiner 108 implements means for calculating headroom.

In operation, the example data retriever 110 retrieves data set(s) from the example predictor data source 104 (e.g., data set “A” having “X” variables) and data set(s) from the example criterion data source 106 (e.g., data set “B” having “Y” variables). The example data sanitizer 112 sanitizes the data sets by, in some examples, soliciting one or more sanitization services from an organization such as Experian®. Generally speaking, a first client that owns and/or otherwise manages the example criterion data source 102 does not wish and/or is not authorized to reveal certain information in a public manner. Similarly, a second client that owns and/or otherwise manages the example predictor data source 104 does not wish and/or is not authorized to reveal certain information in a public manner. However, both the example criterion data source 102 and the example predictor data source 104 might have any number of similarities that, when identified, allow market research efforts to gain valuable insight into market behaviors, consumer behaviors and allow marketing campaigns to be improved. To allow such valuable insights to be used by either client in a manner that does not reveal sensitive information corresponding to consumers and/or panelists, the example data sanitizer 112 may solicit data sanitization and/or obfuscation services from the example data sanitization service 128.

In view of the presumption that there are overlaps in data similarity between the example criterion data source 102 and the example predictor data source 104, the example overlap calculator 114 generates a corresponding overlap data set (e.g., data set “AB”) (or any number of overlap data sets) that, when generated, is stored in the example overlap data store 119. While the example overlap data store 119 is shown as part of the example overlap calculator 114, the overlap data store 119 may reside elsewhere within the example headroom determination system 100 and/or any network accessible location. In some examples, an overlap data set is referred to herein as a merged data set and/or a data set stored in a merged data store 119. The example merged data set stored in the merged data store 119 includes observations on predictor variables (e.g., “X” variables) and criterion variables (e.g., “Y” variables).

Generally speaking, the example criterion data source 102 may include a first type of data, such as data corresponding to observations of consumers purchasing a particular type of product (e.g., milk). In fact, the Nielsen Company® manages panelists as a criterion data source 102 in a manner that satisfies the rigors of statistical expectations for the technical field of market research. Similarly, the example predictor data source 104 may also include data corresponding to observations of consumers purchasing milk, but the number of such observations is typically orders of magnitude greater than that of the example criterion data source 102.

The example field identifier 116 identifies one or more fields in the example criterion data source 102 and the example predictor data source 104 to be used for merging operation(s). For example, both data sources may contain common fields associated with a name (e.g., a name of a consumer, a name of a product), an address (e.g., an address of a consumer, an obfuscated address region of a consumer), a spend quantity (e.g., a number of dollars spent per month by a household), a number of children, an ethnic descriptor, etc. In some examples, the one or more fields in the data sources identified are referred to herein as first tier parameters. First tier parameters typically have a degree of granularity that is less detailed than second tier parameters. The example data joiner 118 merges matching data corresponding to the one or more fields to generate an overlap data set. In some examples, the overlap data set facilitates one or more groupings of households that have commonalities, such as households that spend a threshold amount of money per month, households that reside in a particular geographic location, households that include a threshold number of children, etc. In some examples, these commonalities represent first tier parameters.

While the example overlap calculator 114 identifies household similarities and generates an overlap data set, the example similarity calculator 120 generates similarity metrics between such households based on consumer characteristics in the overlap data set. In some examples, consumer characteristics represent second tier parameters because they are relatively more granular in detail and unique to household members, unlike the first tier parameters that are more attributable to households. For instance, while some households are similar with regard to their particular geographic proximity to each other (e.g., a first tier parameter), those particular households and/or the consumers therein may have very little else in common with each other. As such, the example similarity calculator 120 invokes the example field identifier 116 to identify fields (e.g., second tier parameters) to he used for consumer similarity comparisons. Stated differently, the similarity calculator 120 creates a similarity metric between each observation. The similarity metric is based on, for example, a degree of similar spending on restaurants, a degree of similar spending on specific restaurants, a degree of similar spending on apparel, etc. Fields of interest correspond to observations that exist in the predictor data source 104, and because the predictor data source 104 typically includes a relatively low degree of granularity (e.g., when compared to the criterion data source 102), at least one objective is to impute the relatively more granular characteristics of the criterion data source 102 to appropriate households/consumers of the predictor data source 104. The example similarity calculator 120 generates pairwise similarity metrics between consumers in each database. Fields of interest include, but are not limited to a spend amount by household members at a retailer of interest, a spend amount at restaurants, a spend amount on a particular brand, a particular household income, etc. For example, the criterion data set (e.g., from the example criterion data source 102) may include relatively granular data that indicates a selected consumer spends $100 at retailer “I,” spends $200 at retailer “J,” and spends $300 at retailer “K,” the selected consumer is female with an income of $155,000 and has two children. The example similarity calculator 120 computes similarity metrics) of this consumer to every observation in the merged data set (e.g., the data stored in the example overlap data source 119) on the basis of this information. The example similarity calculator 120 assigns a similarity metric value of 1 for exact same matches (e.g., the exact same spending at retailers “I,” “J,” and “K”), and values between zero and 0.99 for relatively less-similar observations.

Stated differently, the overlap calculator 114 largely focuses on similarities of households between the example criterion data source 102 and the example predictor data source 104, while the example similarity calculator 120 focuses on similarities of consumers within those households of the overlap data set. Because calculated similarity metrics are associated with households, the example overlap data store 119 reveals “lookalike” households. As such, in the event a market researcher has an observation in the example predictor data source 104, examples disclosed herein facilitate the ability to calculate how similar that observation is to one or more of the lookalike households in the overlap data store 119. Further, even though the observation in the example predictor data source 104 is not associated with any panelist data source (e.g., the example criterion data source 102), examples disclosed herein enable that observation (and the associated household) to be imputed with characteristics of the lookalike household corresponding to the panelist data source.

Based on selected consumer fields of interest, the example data retriever 110 retrieves observations from the example criterion data source 102 and observations from the example merged data set. As used herein, observations represent an occurrence of at least one consumer field of interest, such as an observed instance of a household member spending money on a particular product (e.g., milk, a car, a television, etc.). The example similarity calculator 120 calculates a similarity score between pairs of observations retrieved by the example data retriever 110. In some examples, the similarity calculator 120 utilizes a multivariate similarity function, a Jaccard similarity index function, etc., to calculate the similarity score(s). The example data joiner 118 associates calculated similarity scores with the respective households in which the consumer resides that exhibited the behavior corresponding to the consumer field(s) of interest. Such similarity scores also form part of the merged data set.

In some examples, the example principal components calculator 122 performs a principal components analysis (PCA) on the merged data set (e.g., merged/overlap data stored in the example overlap data store 119). The PCA facilitates, in part, an ability to reduce a dimensionality of the stored data to form subgroups of similarity. As such, one or more observations may he selected from logical cohorts of the data stored in the overlap data store 119.

With the merged data store 119 now containing data (e.g., observations) corresponding to similar household mappings and similarity scores, the example merged data store 119 can be utilized to perform predictions of interest. For example, a retailer may have their own predictor data source (e.g., a frequent-shopper card data source) to learn how their customers purchase from the retail establishment. The retailer may have accurate information regarding how many dollars are spent by a consumer on milk each week, but the retailer will have no knowledge of how much spend their customer makes on milk at a different retailer. Examples disclosed herein enable such predictions using both information from the predictor data source and the criterion data source. Such predictions are possible with the aid of the overlap data source 119, and additional marketing strategies are improved with headroom calculations, as disclosed in further detail below.

The example prediction calculator 124 generates an initial prediction. In particular, the prediction calculator 124 invokes the example data retriever 110 to select predictor data of interest. As described above, the predictor data in the example predictor data source 104 (or the predictor data now residing in the overlap data source 119) does not have granular data associated therewith. For instance, an observation of a purchase instance of 2% milk by a consumer in a particular household in the predictor data source 104 may not include detailed demographics information. Ultimately, examples disclosed herein identify respective observations of the example criterion data source 102 to be imputed to the relatively less granular information of the predictor data source 104. The data retriever 110 identifies a threshold number of households from the overlap data source 119 that include (a) household similarities and (b) consumer similarities to the selected observation of interest (e.g., purchase instances of 2% milk) from the criterion data source 102.

The example data retriever 110 collects values corresponding to the predictor data of interest from the threshold number of households (e.g., 250 households having a highest relative similarity to each other). Some households will have members that have purchased 2% milk at varying amounts within a time period of interest, while other households will not have any members that have purchased 2% milk. The example prediction calculator 124 computes an average value weighted by the corresponding similarity values in a manner consistent with example Equation 1.

$${Y}_{P 1} = \frac{\sum S [ ab ] * Y [ ab ]}{\sum S [ ab ]} . \qquad Equation 1$$

In the illustrated example of Equation 1, S[ab] represents the similarity of the consumer to each observation in the merged data set AB, and Y represents a corresponding value of the criterion value in the merged data set AB. Generally speaking, the initial prediction of Y_{P1} for the criterion data set represents a similarity-weighted average of Y for the most similar consumers from the merged data set AB.

While the aforementioned prediction is based on an intersection between (a) granular data from the example criterion data source 102, (b) relatively less granular data from the example predictor data source 104, (c) household similarities and (d) consumer behavior similarities, one potential issue with the initial prediction (Y_{P1}) is that after each consumer in the criterion data set (e.g., data from the example criterion data source 102 that is now stored in the overlap data source 119) is scored, the respective value of Y_{P1} may have a far different distribution than the source prediction values from the merged data (e.g., AB overlap between criterion and predictor). For instance, consider Y as representative spending on new cars in the previous 12-months, and a typical observed value is zero, but a very small percent of consumers spend a relatively large amount (e.g., $20,000 or more) with an average spend of $400. Given these example circumstances, an initial prediction Y_{P1} on the criterion data set will likely have a similar average of $400, but only a small variance resulting in prediction of new car spending of, for example. $20 to $2000 for every consumer in the merged database. Of course, these predictions do not comport with actual behaviors of the consumers because of data distribution skewing. In some examples, the process of generating pairwise similarity metrics causes a degree of skew that overestimates particular behaviors.

Examples disclosed herein ensure that prediction values accurately reflect observed distribution in the merged/overlap data set (e.g., AB data set), In particular, examples disclosed herein generate a resealed prediction Y_{P2} by mapping the distribution of Y_{P1} in the criterion data set to the corresponding distribution of Y in the merged data set (AB). In some examples, the distribution mapper 126 maps the distribution of Y_{P1} to generate the resealed prediction Y_{P2} using a finite n-tile.

For instance, an initial prediction of spending on new cars (e.g., Y_{P1}) may be $600 for a consumer of interest, which is at an 87^{th} percentile of all predictions (e.g., a bell curve distribution). However, in the 87^{th} percentile of new car spending (e.g., Y) in the merged/overlap data set (AB), such spending is $0. A different (e.g., second) example consumer of interest may have a predicted Y_{P1} of $1800, which is in the 98^{th} percentile of all predicted values, and the corresponding 98^{th} percentile of Y in the merged data set (AB) is $25,000. As a result of the example n-tile mapping performed by the example distribution mapper 126, the initial prediction Y_{P1} for the two consumers (e.g., the aforementioned $600 and $1800) are converted into final predictions of Y_{P2} of $0 and $25,000, respectively. Stated differently, the aforementioned process by the distribution mapper 126 verities that predicted values of Y are as similar in distribution as observed Y values. This redistribution removes and/or otherwise reduces a skew effect, and also makes more sense in view of typical expectations of consumer spending on new cars, which is rarely occurring at a value of $600 or $1800. Instead, typical expectations are that new car purchases are not as common (e.g., perhaps 2% of a population purchases new cars during a time period of interest) as, for instance, purchase instances of milk (e.g., perhaps 50% of the same population purchases milk during the time period of interest). Accordingly, the resealed distributions correct values that are expected by real-world consumer behaviors.

Examples disclosed herein also develop insight beyond a consumer's usual spending behaviors and identifies potential spending behaviors. The example headroom calculator 108 predicts a potential for increase in spending (“headroom”) on a particular criterion value. As used herein, “headroom” reflects a metric indicative of an amount upon which a consumer spend can increase. Stated differently, a consumer's headroom indicates a potential increase in spending. For example, consumer A may exhibit a spend value of $30, in which consumer A have many lookalikes in the overlap data store 119 as a result of similarity calculations. A market analyst may seek information regarding how much consumer A can potentially spend beyond that value of $30. Similarity cohorts (lookalikes) from the overlap data set (e.g., stored in the overlap data store 119) may range from $0 to $100, so there is a distribution occurring (e.g., could be a bell curve or any other distribution). Determining the headroom is based on a potential for a potential jump in the standard deviation of this distribution. In statistical terms, one standard deviation reflects approximately 68% of the cohort.

To illustrate, consider two hypothetical consumers in which a spending on a particular product is to he predicted. Consumer 1 has five (5) highly similar observations in the merged/overlap data set (AB) with respective spending observations of ($100, $100, $0, $0, $0). Consider consumer 2 having five (5) highly similar observations in the merged/overlap data set (AB) of ($42, $41, $40, $39, $38). Note that both consumers would have an expected spending (average) of approximately $40, but the particular spending magnitudes to reach this same average value are substantially different (e.g., large variance). The example headroom calculator 108 generates a headroom value (HRY) in a manner consistent with example Equation 2 to identify that consumer 1 would be considered as having a relatively higher spending “headroom.”

$$HRY = C * \sqrt{\frac{\sum ( S [ a b ] * {( {Y}_{P 1} - Y [ ab ] )}^{2} )}{\sum S [ ab ]}} . \qquad Equation 2$$

In the illustrated example of Equation 2, C represents a scaling constant that does not impact the ranking of headroom of one consumer to another, but only the absolute value. A value of C=1 reflects the belief that the consumer's predicted spending could be moved from the average of a similar merged data set (AB) cohort to a particular percentile (e.g., 68^{th}) of another cohort. Continuing with the example values above, consumers 1 and 2 would each have a predicted spending of $40, but consumer 1 would have a predicted headroom of $49, and consumer 2 would have a corresponding headroom of only $1.41.

In some examples, different headroom values are compared to one or more thresholds to cause a selection of a particular household and/or consumer that is a better candidate for targeted advertising. In such examples, when a threshold value of headroom is satisfied (e.g., a threshold dollar amount, a threshold percentage difference, etc.), the example headroom calculator 108 triggers and/or otherwise causes targeted advertising content to be exposed to the household and/or consumer of interest, thereby improving an efficiency of an advertising campaign (e.g., reducing wasted advertising spend on those households and/or consumers that do not have adequate spend potential to justify targeting).

While an example manner of implementing the headroom calculator 108 of FIG. 1 is illustrated in FIG. 1, one or more of the elements, processes and/or devices illustrated in FIG. 1 may be combined, divided, rearranged, omitted, eliminated and/or implemented in any other way. Further, the example data retriever 110, the example data sanitizer 112, the example prediction calculator 124, the example distribution mapper 126, the example overlap calculator 114, the example field identifier 116, the example data joiner 118, the example similarity calculator 120, the example principal components calculator 122 and/or, more generally, the example headroom calculator 108 of FIG. 1 may be implemented by hardware, software, firmware and/or any combination of hardware, software and/or firmware. Thus, for example, any of the example data retriever 110, the example data sanitizer 112, the example prediction calculator 124, the example distribution mapper 126, the example overlap calculator 114, the example field identifier 116, the example data joiner 118, the example similarity calculator 120, the example principal components calculator 122 and/or, more generally, the example headroom calculator 108 of FIG. 1 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data retriever 110, the example data sanitizer 112, the example prediction calculator 124, the example distribution mapper 126, the example overlap calculator 114, the example field identifier 116, the example data joiner 118, the example similarity calculator 120, the example principal components calculator 122 and/or, more generally, the example headroom calculator 108 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example headroom calculator 108 of FIG. 1 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

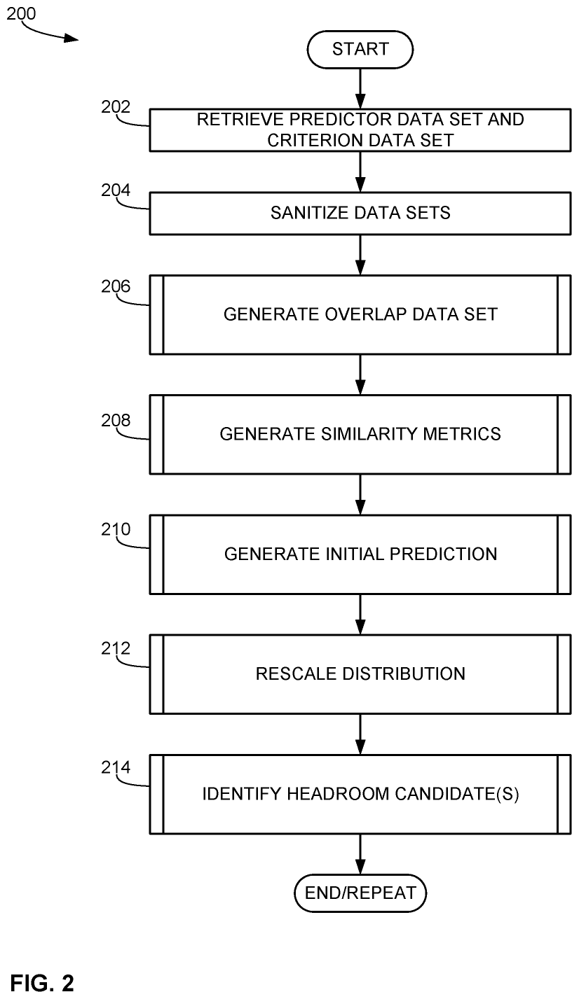

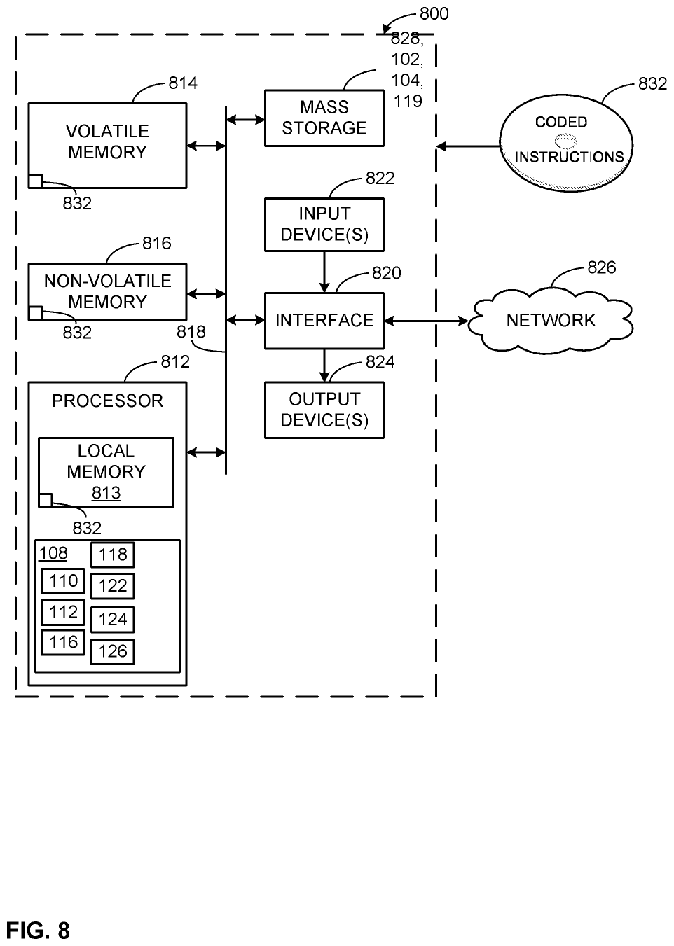

Flowcharts representative of example hardware logic, machine readable instructions, hardware implemented state machines, and/or any combination thereof for implementing the headroom determination system 100 and, more specifically, the headroom calculator 108 of FIG. 1 is shown in FIGS. 2-7. The machine readable instructions may be one or more executable programs or portion(s) of an executable program for execution by a computer processor and/or processor circuitry, such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIGS. 2-7, many other methods of implementing the example headroom determination system 100 and/or, more specifically, the example headroom calculator 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code. etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift. etc.

As mentioned above, the example processes of FIGS. 2-7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects andlor things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The program 200 of FIG. 2 includes block 202, where the example data retriever 110 retrieves data set(s) from the example predictor data source 104 (e.g., data set “A” having “X” variables) and data set(s) from the example criterion data source 106 (e.g., data set “B” having “Y” variables). As described above, the example data sanitizer 112 sanitizes the data sets (block 204) by, in some examples, soliciting one or more sanitization services from an organization such as Experian®. The example overlap calculator 114 generates a corresponding overlap data set (block 206) (e.g., data set “AB”) (or any number of overlap data sets) that, when generated, is stored in the example overlap data store 119. The example similarity calculator 120 generates similarity metrics between such households based on consumer characteristics in the overlap data set (block 208). The example prediction calculator 124 generates an initial prediction (block 210), and the example distribution mapper 126 maps and/or otherwise re-scales the distribution (block 212). The example headroom calculator 108 calculates headroom candidates and corresponding household and/or household member headroom values (block 214).

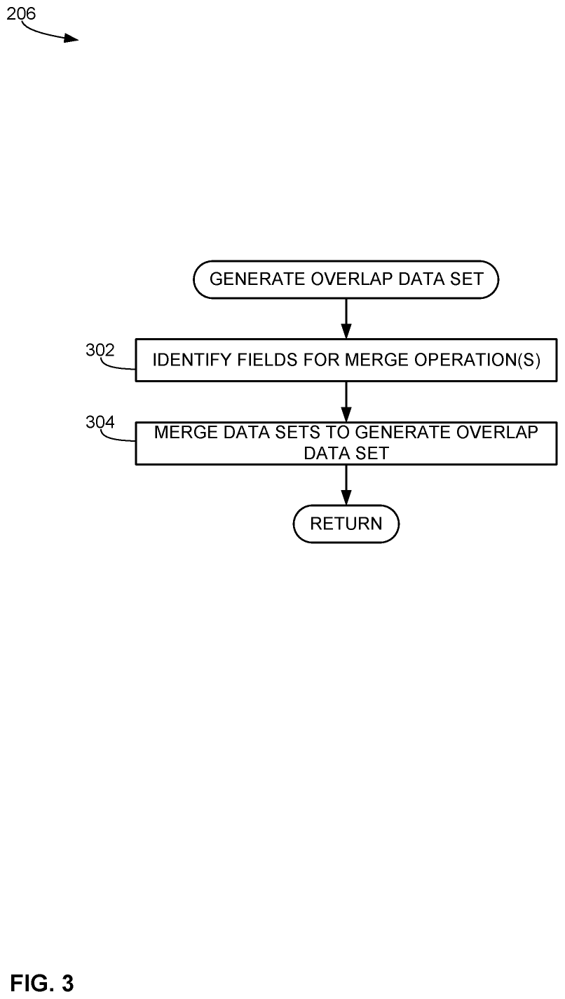

FIG. 3 illustrates additional detail corresponding to the example overlap calculator 114 generating overlap data set(s) of block 206. In the illustrated example of FIG. 3, the example field identifier 116 identifies one or more fields in the example criterion data source 102 and the example predictor data source 104 to be used for merging operation(s) (block 302). The example data joiner 118 merges matching data corresponding to the one or more fields to generate an overlap data set (block 304). In some examples, the overlap data set facilitates one or more groupings of households that have commonalities, such as households that spend a threshold amount of money per month, households that reside in a particular geographic location, households that include a threshold number of children, etc. Control then returns to block 208 of FIG. 2.

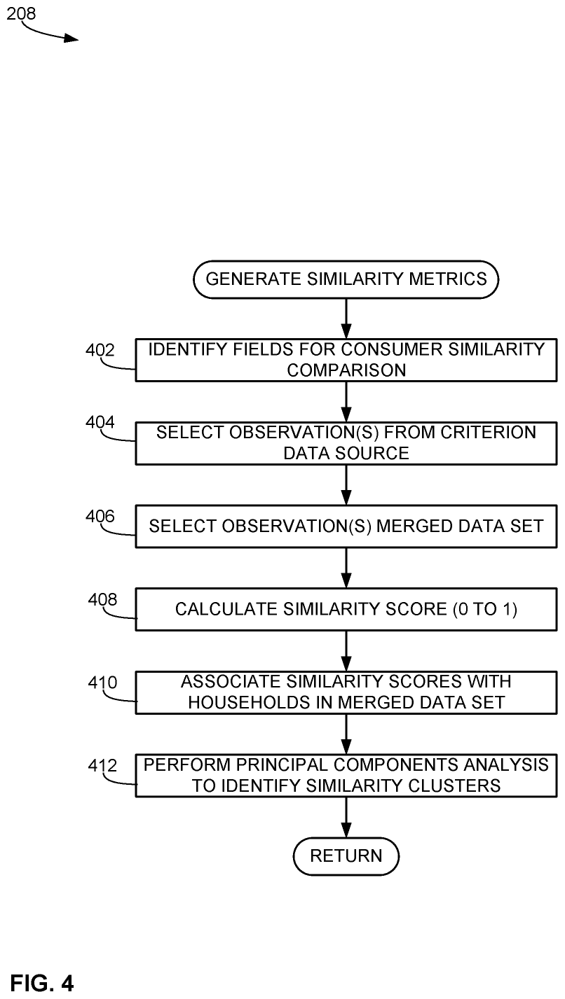

FIG. 4 illustrates additional detail corresponding to the example similarity calculator 120 generating similarity metrics of block 208. In the illustrated example of FIG. 4, the example field identifier 116 identifies fields for consumer similarity comparison(s) (block 402). The example data retriever 110 selects observations from the example criterion data source (block 404) and selects observations from the merged data set (block 406). The example similarity calculator 120 calculates similarity scores (block 408), such as pairwise similarity metrics based on one or more multivariate similarity techniques. The example data joiner 118 associates calculated similarity scores with the respective households in which the consumer resides that exhibited the behavior corresponding to the consumer field of interest (block 410). The example principal components calculator 122 performs a principal components analysis (PCA) on the merged data set (e.g., merged/overlap data stored in the example overlap data store 119) (block 412). Control then returns to block 210 of FIG. 2.

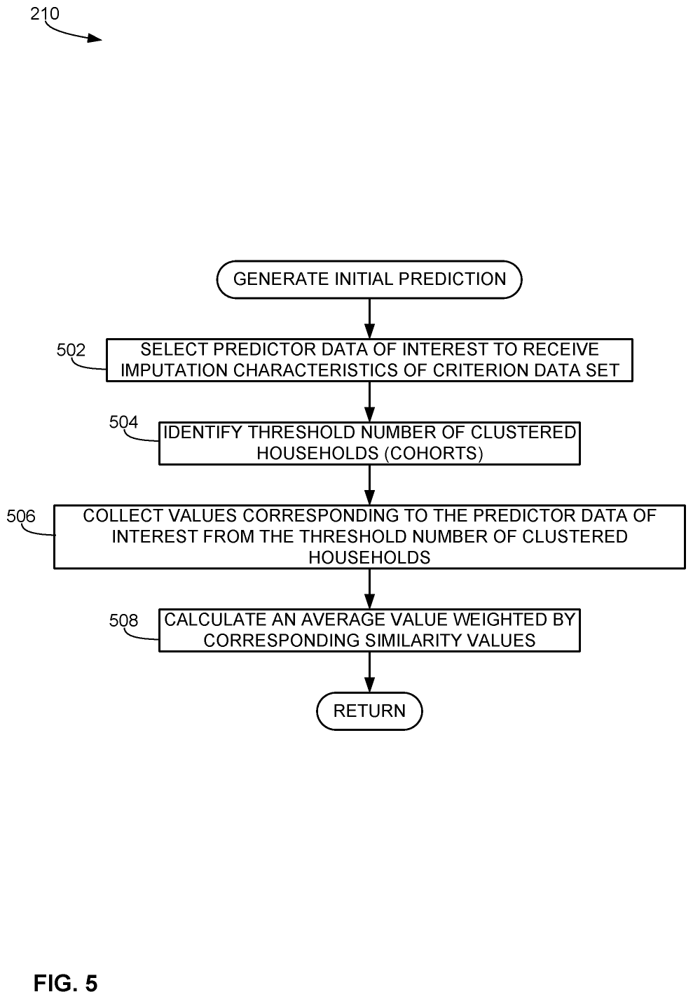

FIG. 5 illustrates additional detail corresponding to the example prediction calculator 124 generating an initial prediction of block 210. In the illustrated example of FIG. 5, the example data retriever 110 selects predictor data of interest that is to receive imputed characteristics of data from the criterion data set (block 502), The example data retriever 110 identifies a threshold number of households from the overlap data source 119 that include (a) household similarities and (b) consumer similarities to the selected observation of interest (block 504) (e,g., purchase instances of 2% milk) from the criterion data source 102. The example data retriever 110 collects values corresponding to the predictor data of interest from the threshold number of households (block 506) (e.g., 250 households having a highest relative similarity to each other). The example prediction calculator 124 computes an average value weighted by the corresponding similarity values (block 508) in a manner consistent with example Equation 1, as discussed above. Control then returns to block 212 of FIG. 2.

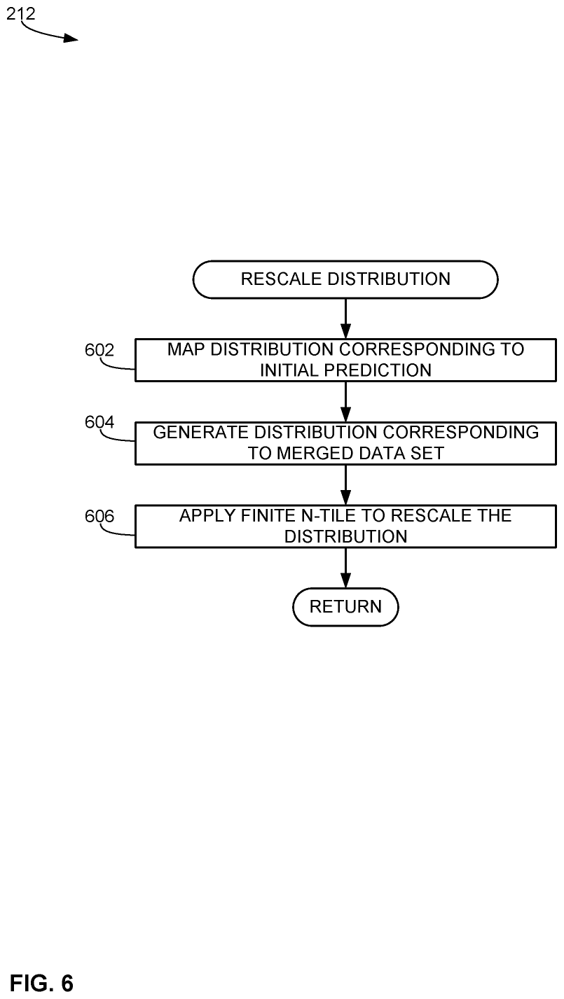

FIG. 6 illustrates additional detail corresponding to the example distribution mapper 126 resealing the distribution of block 212. In the illustrated example of FIG. 6, the example distribution mapper 126 maps the distribution corresponding to the initial prediction (e.g., Y_{P1}) (block 602). Additionally, the example distribution mapper 126 generates a distribution corresponding to the merged data set (block 604) and applies a finite n-tile operation(s) to rescale the distribution in a manner that reduces skew and reflects a prediction that is more consistent with real-world consumer behaviors (block 606). Control then returns to block 214 of FIG. 2.

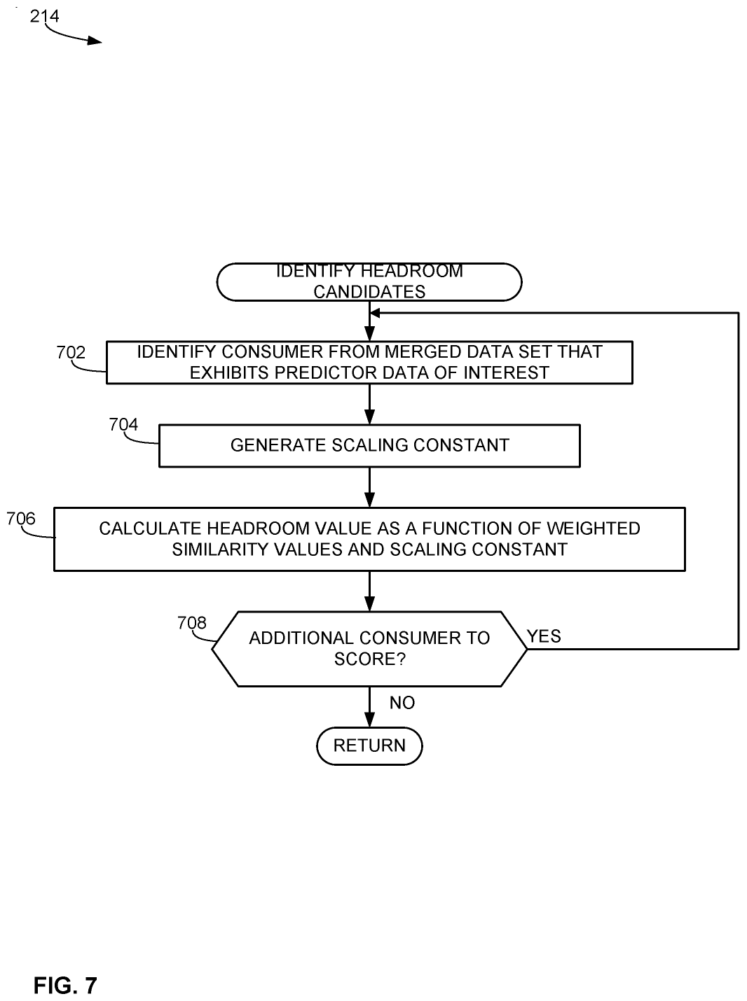

FIG. 7 illustrates additional detail corresponding to the example headroom calculator 108 identifying headroom candidate(s) and generating headroom values of block 214. In the illustrated example of FIG. 7, the example headroom calculator 108 identifies and/or otherwise selects a consumer from the merged data set that exhibits predictor data of interest (block 702). In some examples, the predictor data of interest is a behavior, such as milk purchases. In some examples, the predictor data of interest is one consumer from a cohort of similar consumers that have compatible and/or otherwise numerically similar values of the aforementioned similarity metrics. The example headroom calculator 108 generates a scaling constant (C), which may be derived from prior market studies and corresponding expectations of purchase behaviors (block 704). The example headroom calculator 108 calculates a headroom value for the selected consumer as a function of weighted similarity values and the scaling constant (block 706). In some examples, the headroom values are calculated by the example headroom calculator 108 in a manner consistent with example Equation 2. The example headroom calculator 108 determines whether there are one or more additional consumers to score (block 708) and, if so, control returns to block 702. Otherwise the program 214 exits. In some examples, the example headroom calculator 108 performs a relative comparison of calculated headroom values to identify respective ones that exhibit a greatest degree of variance. Such behaviors allow the headroom calculator 108 to select corresponding consumers as targets for targeting advertising to occur in a more efficient manner.

FIG. 8 is a block diagram of an example processor platform 800 structured to execute the instructions of FIGS. 2-7 to implement the headroom determination system 100 and/or the example headroom calculator 108 of FIG. 1. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example data retriever 110, the example data sanitizer 112, the example prediction calculator 124, the example distribution mapper 126, the example overlap calculator 114, the example field identifier 116, the example data joiner 118, the example similarity calculator 120, the example principal components calculator 122 and/or, more generally, the example headroom calculator 108 of FIG. 1.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820, The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (MID) drives.

The machine executable instructions 832 of FIGS. 2-7 may be stored in the mass storage device 828, in the volatile memory 814, in the non-volatile memory 816, and/or on a removable non-transitory computer readable storage medium such as a CD or DVD.

From the foregoing, it will be appreciated that example methods, apparatus and articles of manufacture have been disclosed that enable calculation of valuable marketing metrics in the technical field of market research that further enable selection of particular targeted advertisements and/or selection of particular consumers and households that should be the target of such advertisements. Such metric calculation and selection avoid discretionary errors that are caused by, for example, market research personnel that otherwise operate with a “gut instinct” when selecting households and/or consumers to be the basis of targeted advertising. Examples disclosed herein also rely on the specific and unique computational structures to facilitate calculations that would otherwise not be possible by manual human effort. For instance, a typical criterion data source (e.g., the example criterion data source 102 of FIG. 1) includes at least 50,000 to 100,000 panelists to satisfy rigors of statistical significance, and a typical predictor data source (e.g., the example predictor data source 104 of FIG. 1) includes tens or hundreds of millions of respondents and/or households. Such volumes of data make any manual processing of examples disclosed herein impractical

Example methods, apparatus, systems, and articles of manufacture to determine headroom metrics from merged data sources are disclosed herein. Further examples and combinations thereof include the following:

Example 1 includes an apparatus including a data retriever to retrieve a first data set and a second data set, the first and second data sets including observations, an overlap calculator to merge respective ones of the observations to form an overlap data set, the respective ones of the observations merged based on first tier parameters, a similarity calculator to calculate similarity scores for pairs of the respective ones of the observations in the overlap data set, the similarity score based on second tier parameters, and a data joiner to associate respective ones of the similarity scores with corresponding households associated with the respective ones of the observations.

Example 2 includes the apparatus as defined in example 1, further including a principal components calculator to identify similarity clusters in the overlap data set.

Example 3 includes the apparatus as defined in example 2, wherein the data retriever is to identify a threshold number of observations from the similarity clusters, and collect values corresponding to a behavior of interest from the threshold number of observations.

Example 4 includes the apparatus as defined in example 3, further including a prediction calculator to calculate an average value of the collected values based on the similarity scores.

Example 5 includes the apparatus as defined in example 1, further including a headroom calculator to select behavior observations corresponding to a first consumer of interest and a second consumer of interest from the overlap data set, and calculate a headroom value of the first and second consumer based on respective values of the behavior observations.

Example 6 includes the apparatus as defined in example 5, wherein the headroom calculator is to select the first consumer of interest or the second consumer of interest based on a greater one of the headroom value.

Example 7 includes the apparatus as defined in example 6, wherein the headroom calculator is to cause targeted advertising to be directed to the selected first or second consumer of interest.

Example 8 includes at least one non-transitory computer readable medium including instructions that, when executed, cause at least one processor to at least retrieve a first data set and a second data set, the first and second data sets including observations, merge respective ones of the observations to form an overlap data set, the respective ones of the observations merged based on first tier parameters, calculate similarity scores for pairs of the respective ones of the observations in the overlap data set, the similarity score based on second tier parameters, and associate respective ones of the similarity scores with corresponding households associated with the respective ones of the observations.

Example 9 includes the at least one computer readable medium as defined in example 8, wherein the instructions, when executed, cause the at least one processor to identify similarity clusters in the overlap data set.

Example 10 includes the at least one computer readable medium as defined in example 9, wherein the instructions, when executed, cause the at least one processor to identify a threshold number of observations from the similarity clusters, and collect values corresponding to a behavior of interest from the threshold number of observations.

Example 11 includes the at least one computer readable medium as defined in example 10, wherein the instructions, when executed, cause the at least one processor to calculate an average value of the collected values based on the similarity scores.

Example 12 includes the at least one computer readable medium as defined in example 8, wherein the instructions, when executed, cause the at least one processor to select behavior observations corresponding to a first consumer of interest and a second consumer of interest from the overlap data set, and calculate a headroom value of the first and second consumer based on respective values of the behavior observations.

Example 13 includes the at least one computer readable medium as defined in example 12, wherein the instructions, when executed, cause the at least one processor to select the first consumer of interest or the second consumer of interest based on a greater one of the headroom value.

Example 14 includes the at least one computer readable medium as defined in example 13, wherein the instructions, when executed, cause the at least one processor to cause targeted advertising to be directed to the selected first or second consumer of interest.

Example 15 includes a system including means for retrieving data to retrieve a first data set and a second data set, the first and second data sets including observations, means for calculating overlap to merge respective ones of the observations to torn an overlap data set, the respective ones of the observations merged based on first tier parameters, means for calculating similarity to calculate similarity scores for pairs of the respective ones of the observations in the overlap data set, the similarity score based on second tier parameters, and means for joining to associate respective ones of the similarity scores with corresponding households associated with the respective ones of the observations.

Example 16 includes the system as defined in example 15, further including means for calculating principal components to identify similarity clusters in the overlap data set.

Example 17 includes the system as defined in example 16, wherein the data retrieving means is to identify a threshold number of observations from the similarity clusters, and collect values corresponding to a behavior of interest from the threshold number of observations.

Example 18 includes the system as defined in example 17, further including means for calculating predictions to calculate an average value of the collected values based on the similarity scores.

Example 19 includes the system as defined in example 15, further including means for calculating headroom to select behavior observations corresponding to a first consumer of interest and a second consumer of interest from the overlap data set, and calculate a headroom value of the first and second consumer based on respective values of the behavior observations.

Example 20 includes the system as defined in example 19, wherein the headroom calculating means is to select the first consumer of interest or the second consumer of interest based on a greater one of the headroom value.

Example 21 includes the system as defined in example 20, wherein the headroom calculating means is to cause targeted advertising to be directed to the selected first or second consumer of interest.

Example 22 includes a method including retrieving, by executing an instruction with at least one processor, a first data set and a second data set, the first and second data sets including observations, merging, by executing an instruction with the at least one processor, respective ones of the observations to form an overlap data set, the respective ones of the observations merged based on first tier parameters, calculating, by executing an instruction with the at least one processor, similarity scores for pairs of the respective ones of the observations in the overlap data set, the similarity score based on second tier parameters, and associating, by executing an instruction with the at least one processor, respective ones of the similarity scores with corresponding households associated with the respective ones of the observations.

Example 23 includes the method as defined in example 22, further including identifying similarity clusters in the overlap data set.

Example 24 includes the method as defined in example 23, further including identifying a threshold number of observations from the similarity clusters, and collecting values corresponding to a behavior of interest from the threshold number of observations.

Example 25 includes the method as defined in example 24, further including calculating an average value of the collected values based on the similarity scores.

Example 26 includes the method as defined in example 22, further including, selecting behavior observations corresponding to a first consumer of interest and a second consumer of interest from the overlap data set, and calculating a headroom value of the first and second consumer based on respective values of the behavior observations.

Example 27 includes the method as defined in example 26, further including selecting the first consumer of interest or the second consumer of interest based on a greater one of the headroom value.

Example 28 includes the method as defined in example 27, further including causing targeted advertising to be directed to the selected first or second consumer of interest.

Examples disclosed herein disclose means for performing one or more objectives and/or methods. Such example means are hardware.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory;
instructions in the apparatus; and
processor circuitry to execute the instructions to instantiate:
data retriever circuitry to retrieve a first data set and a second data set, the first and second data sets including observations;
overlap calculator circuitry to merge respective ones of the observations to form an overlap data set, the respective ones of the observations merged based on first tier parameters;
similarity calculator circuitry to calculate similarity scores for pairs of the respective ones of the observations in the overlap data set, the similarity score based on second tier parameters; and
data joiner circuitry to associate respective ones of the similarity scores with corresponding households associated with the respective ones of the observations.

2. The apparatus as defined in claim 1, wherein the instructions are to instantiate principal components calculator circuitry to identify similarity clusters in the overlap data set.

3. The apparatus as defined in claim 2, wherein the data retriever circuitry is to:
identify a threshold number of observations from the similarity clusters; and
collect values corresponding to a behavior of interest from the threshold number of observations.

4. The apparatus as defined in claim 3, wherein the instructions are to instantiate prediction calculator circuitry to calculate an average value of the collected values based on the similarity scores.

5. The apparatus as defined in claim 1, wherein the instructions are to instantiate headroom calculator circuitry to:
select behavior observations corresponding to a first consumer of interest and a second consumer of interest from the overlap data set; and
calculate a headroom value of the first and second consumer based on respective values of the behavior observations.

6. The apparatus as defined in claim 5, wherein the headroom calculator circuitry is to select the first consumer of interest or the second consumer of interest based on a greater one of the headroom value.

7. The apparatus as defined in claim 6, wherein the headroom calculator circuitry is to cause targeted advertising to be directed to the selected first or second consumer of interest.

8. At least one non-transitory computer readable medium comprising instructions that, when executed, cause at least one processor to at least:
retrieve a first data set and a second data set, the first and second data sets including observations;
merge respective ones of the observations to form an overlap data set, the respective ones of the observations merged based on first tier parameters;
calculate similarity scores for pairs of the respective ones of the observations in the overlap data set, the similarity score based on second tier parameters; and
associate respective ones of the similarity scores with corresponding households associated with the respective ones of the observations.

9. The at least one computer readable medium as defined in claim 8, wherein the instructions, when executed, cause the at least one processor to identify similarity clusters in the overlap data set.

10. The at least one computer readable medium as defined in claim 9, wherein the instructions, when executed, cause the at least one processor to:
identify a threshold number of observations from the similarity clusters; and
collect values corresponding to a behavior of interest from the threshold number of observations.

11. The at least one computer readable medium as defined in claim 10, wherein the instructions, when executed, cause the at least one processor to calculate an average value of the collected values based on the similarity scores.

12. The at least one computer readable medium as defined in claim 8, wherein the instructions, when executed, cause the at least one processor to:
select behavior observations corresponding to a first consumer of interest and a second consumer of interest from the overlap data set; and
calculate a headroom value of the first and second consumer based on respective values of the behavior observations.

13. The at least one computer readable medium as defined in claim 12, wherein the instructions, when executed, cause the at least one processor to select the first consumer of interest or the second consumer of interest based on a greater one of the headroom value.

14. The at least one computer readable medium as defined in claim 13, wherein the instructions, when executed, cause the at least one processor to cause targeted advertising to be directed to the selected first or second consumer of interest.

15. A system comprising:
means for retrieving data to retrieve a first data set and a second data set, the first and second data sets including observations;
means for calculating overlap to merge respective ones of the observations to form an overlap data set, the respective ones of the observations merged based on first tier parameters;
means for calculating similarity to calculate similarity scores for pairs of the respective ones of the observations in the overlap data set, the similarity score based on second tier parameters; and
means for joining to associate respective ones of the similarity scores with corresponding households associated with the respective ones of the observations.

16. The system as defined in claim 15, further including means for calculating principal components to identify similarity clusters in the overlap data set.

17. The system as defined in claim 16, wherein the data retrieving means is to:
identify a threshold number of observations from the similarity clusters; and
collect values corresponding to a behavior of interest from the threshold number of observations.

18. The system as defined in claim 17, further including means for calculating predictions to calculate an average value of the collected values based on the similarity scores.

19. The system as defined in claim 15, further including means for calculating headroom to:
select behavior observations corresponding to a first consumer of interest and a second consumer of interest from the overlap data set; and
calculate a headroom value of the first and second consumer based on respective values of the behavior observations.

20. The system as defined in claim 19, wherein the headroom calculating means is to select the first consumer of interest or the second consumer of interest based on a greater one of the headroom value.

21. The system as defined in claim 20, wherein the headroom calculating means is to cause targeted advertising to be directed to the selected first or second consumer of interest.

22. A method comprising:
retrieving, by executing an instruction with at least one processor, a first data set and a second data set, the first and second data sets including observations;
merging, by executing an instruction with the at least one processor, respective ones of the observations to form an overlap data set, the respective ones of the observations merged based on first tier parameters;
calculating, by executing an instruction with the at least one processor, similarity scores for pairs of the respective ones of the observations in the overlap data set, the similarity score based on second tier parameters; and
associating, by executing an instruction with the at least one processor, respective ones of the similarity scores with corresponding households associated with the respective ones of the observations.

23. The method as defined in claim 22, further including identifying similarity clusters in the overlap data set.

24. The method as defined in claim 23, further including:
identifying a threshold number of observations from the similarity clusters; and
collecting values corresponding to a behavior of interest from the threshold number of observations.

25. The method as defined in claim 24, further including calculating an average value of the collected values based on the similarity scores.

26. The method as defined in claim 22, further including;
selecting behavior observations corresponding to a first consumer of interest and a second consumer of interest from the overlap data set; and
calculating a headroom value of the first and second consumer based on respective values of the behavior observations.

27. The method as defined in claim 26, further including selecting the first consumer of interest or the second consumer of interest based on a greater one of the headroom value.

28. The method as defined in claim 27, further including causing targeted advertising to be directed to the selected first or second consumer of interest.
